(19) United States
(12) Patent Application Publication
(10) Pub. No.: US 2020/0311809 A1
(43) Pub. Date: Oct. 1, 2020

(54) METHOD AND SYSTEM OF EARLY SETTLEMENT CAPPING PROCESS

(71) Applicants: Harshil Mathur, bengaluru (IN); Priyanka Jain, bengaluru (IN); Prerit Khandelwal, bengaluru (IN); Ayush Bansal, bengaluru (IN); Shashank Mehta, bengaluru (IN)

(72) Inventors: Harshil Mathur, bengaluru (IN); Priyanka Jain, bengaluru (IN); Prerit Khandelwal, bengaluru (IN); Ayush Bansal, bengaluru (IN); Shashank Mehta, bengaluru (IN)

(21) Appl. No.: 16/675,479

(22) Filed: Nov. 6, 2019

Related U.S. Application Data
(60) Provisional application No. 62/825,815, filed on Mar. 29, 2019.

(51) Int. Cl. G06Q 40/02; G06Q 20/40; G06Q 20/02

(52) U.S. Cl. CPC G06Q 40/025; G06Q 20/027; G06Q 20/405

(57) ABSTRACT

In one aspect, computerized method for determining a maximum daily limit for a merchant on a settlement includes the step of, with an early settlement capping module operating in a server. The method includes the step of deciding a maximum lending limit. The maximum lending limit is used for a setup of a payment gateway with a surplus amount that a nodal account utilizes for providing a lending service to a set of merchants. The method includes the step of analyzing the impact of a set of alternative factors that are used as a cap value for the maximum lending limit. The cap value comprises an upper limit put to a daily settlement done to a merchant in the set of merchants in order to prevent risk and optimally lend float. The method includes the step of, based on the cap value, implementing a lending operation through the lending service to the set of merchants.

### CLAIM OF PRIORITY

This application claims priority to and incorporates by reference U.S. Provisional Application No. 62/825,815, titled METHOD AND SYSTEM OF EARLY SETTLEMENT CAPPING PROCESS, and filed on 29 Mar. 2019.

### BACKGROUND

### Field of the Invention

The invention is in the field of electronic payments and more specifically to a method, system and apparatus of implementing an early settlement capping process.

### Description of the Related Art

There is a need to put an upper limit to an early settlement amount that arises to meet the objective of risk prevention and optimal float lending. If early settlements are not capped, then at the days when unusually high payments occur for a particular merchant there are high chances of float running out of capacity to provide for all the settlements. Accordingly, improvements to implementing an early settlement capping process are desired.

### BRIEF SUMMARY OF THE INVENTION

In one aspect, computerized method for determining a maximum daily limit for a merchant on a settlement includes the step of, with an early settlement capping module operating in a server. The method includes the step of deciding a maximum lending limit. The maximum lending limit is used for a setup of a payment gateway with a surplus amount that a nodal account utilizes for providing a lending service to a set of merchants. The method includes the step of analyzing the impact of a set of alternative factors that are used as a cap value for the maximum lending limit. The cap value comprises an upper limit put to a daily settlement done to a merchant in the set of merchants in order to prevent risk and optimally lend float. The method includes the step of, based on the cap value, implementing a lending operation through the lending service to the set of merchants.

### BRIEF DESCRIPTION OF THE DRAWINGS

FIG. 1 illustrates a schematic representation of a network environment implementing a system, in accordance with an implementation of the present subject matter.

FIG. 2 illustrates an example process for determining a cap value, according to some embodiments.

FIG. 3 illustrates an example process for accounting for dynamism in a cap value provided by process 200, according to some embodiments.

FIG. 4 illustrates an example process for utilizing metrics for indicating a performance of cap alternative(s), according to some embodiments.

FIG. 5 illustrates an example process for float optimization, according to some embodiments.

FIG. 6 is a block diagram of a sample computing environment that can be utilized to implement some embodiments.

The Figures described above are a representative set, and are not exhaustive with respect to embodying the invention.

### DESCRIPTION

Disclosed are a system, method, and article of manufacture for early settlement capping. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Electronic payment can be payment system used to settle financial transactions through the transfer of monetary value, and includes the institutions, instruments, people, rules, procedures, standards, and technologies that make such an exchange possible. Example electronic payments can include e-commerce payments, electronic bill payments, etc.

Straight-through processing (STP) is an initiative used by financial companies to speed up the transaction process. Within this frame, T+0 (T+1, T+2, T+3, etc.) abbreviations refer to the settlement date of security transactions. The ‘T’ is transaction date (e.g. the day the transaction takes place). The integers (e.g. 0, 1, 2, 3, etc.) denote the number of days after the transaction date the settlement and/or the transfer of money and security ownership occurs.

Additional example definitions are provided herein.

Example Systems

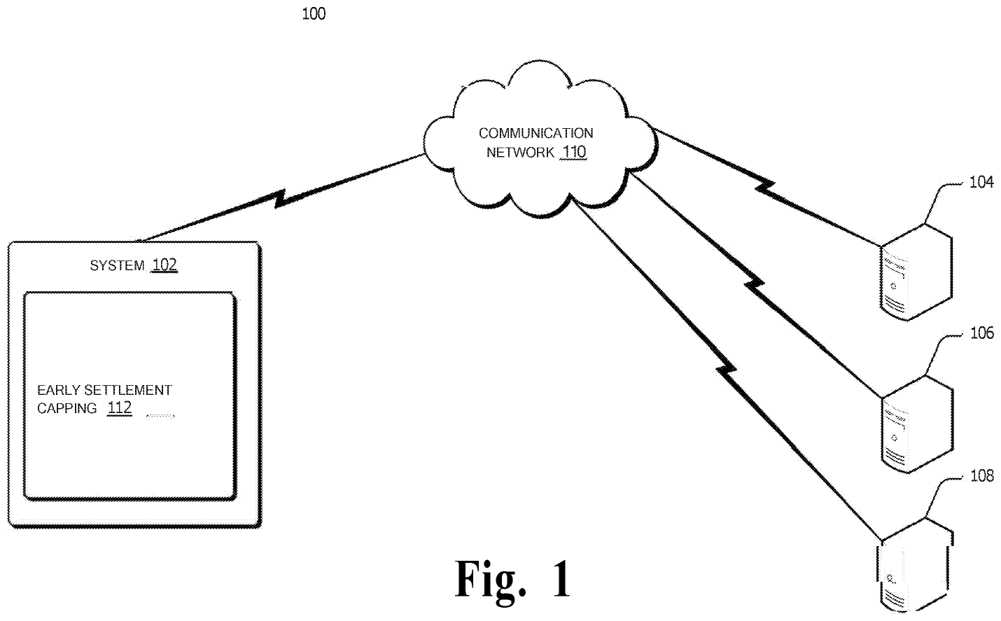

FIG. 1 illustrates a schematic representation of a network environment 100 implementing a system 102, in accordance with an implementation of the present subject matter.

A process for deciding the maximum daily limit for a merchant on T+0 settlement is disclosed. An upper limit to the early settlement amount can be used to meet the objective of risk prevention and optimal float lending. If early settlements are not capped, then at the days when unusually high payments occur for a particular merchant there are high chances of float running out of capacity to provide for all the settlements.

More specifically, the network environment 100 may either be a public distributed environment or may be a private closed network environment. The network environment 100 includes the system 102 communicatively coupled to a first server 104, a second server 106, and a third server 108 through a communication network 110. The system 102 may be also referred to as computing device 102. The first server 104 may be a database server on an application server employed by the financial institution to communicate with the system 102 for the electronic payment. The second server 106 may be a database server or an application server of a merchant with whom the user performs a transaction, such as purchasing goods, for which the user makes the electronic payment. The merchant may be, for example, an e-commerce portal. The third server 108 may be a database server or an application server that may mediate communication between the first server 104 and the system 102.

The system 102 may be implemented as any computing system, which may be, but is not restricted to, a server, a workstation, a desktop computer, a laptop, a smartphone, a personal digital assistant (PDA), a tablet, a virtual host, and an application. The system 102 may also be a machine-readable instructions-based implementation or a hardware-based implementation, or a combination thereof.

The communication network 108 may be a wireless or a wired network, or a combination thereof. The communication network 108 may be a collection of individual networks, interconnected with each other and functioning as a single large network (e.g., the internet or an intranet). Examples of such individual networks include, but are not restricted to, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 108 includes various network entities, such as transceivers, gateways, and routers; however, such details have been omitted for ease of understanding.

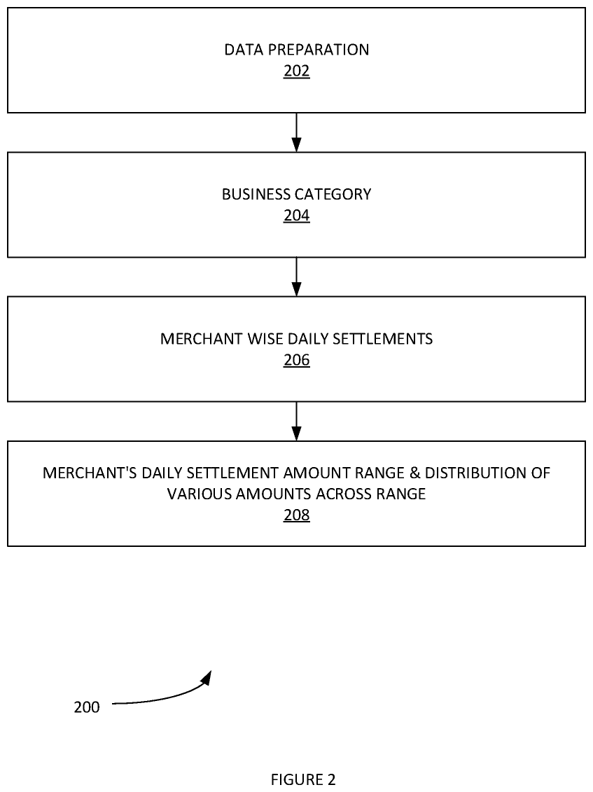

In an implementation of the present subject matter, the system 102 includes an early settlement capping module 112. Example functions of the early settlement capping module 112 are explained in detail with reference to FIG. 2-5. Accordingly, capping module 112 can be used to implement processes 200-500 infra. Capping module 112 can be used to decide a maximum lending limit. The maximum lending limit can be used for a setup of a payment gateway with a surplus amount that nodal account utilizes for providing a lending service to its merchants. The lending can be implemented on a daily basis (e.g. settling money earlier than the agreed schedule). The amount lent daily (or settled early) is not fixed and is dependent on various factors. Example factors can include, inter alia: a merchant's business category; near players to the merchant within said category; the range of daily volumes; the distribution of daily volumes within said range; etc. The objective is to lend the surplus amount such that it is a win-win situation for merchants as well as the lending entity. To understand a cap value suits a specified objective, capping module 112 can analyze the impact of various alternatives that can be used as a cap value. As a result, the ideal cap value for a setup can be obtained as: Maximum(Minimum(Percentile Ratio Amount, Category Bin Maximum Amount), 99th Percentile Amount).

The system 102 can include a processor(s) 402 to run at least one operating system and other applications and services. The system can also include an interface(s) and a memory. Further, the system 102 can include various module(s) and data. In addition, the system can include a display.

The processor(s), amongst other capabilities, may be configured to fetch and execute computer-readable instructions stored in the memory. The processor(s) may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labeled as “processor(s)”, may be provided through the use of dedicated hardware as well as hardware capable of executing machine readable instructions.

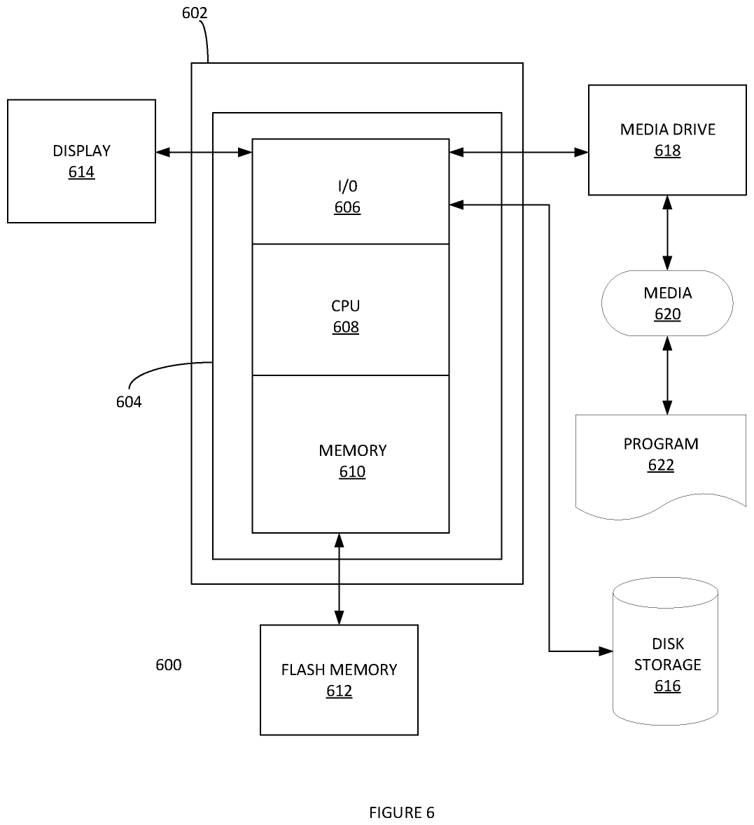

When provided by a processor, the functions may be provided by a single dedicated processor, by a single shared processor, or by a plurality of individual processors, some of which may be shared. Moreover, explicit use of the term “processor” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included. Other computing systems that can be integrated with the various elements of system 102 are provided in FIG. 6 infra.

FIG. 2 illustrates an example process 200 for determining a cap value, according to some embodiments. Process 200 can provide a cap value. Cap value is an upper limit put to the daily settlement done to the merchant in order to prevent risk and optimally lend float. The cap value can provide for covering settlement cases for a given merchant. At the same time, process 200 can enable maximum utilization of an allocated cap value.

In step 202, process 200 can implement data preparation operations. In step 202, merchant-wise daily settlement data is consolidated for all the active merchants across various business categories. Example business categories include, inter alia: ecommerce, pharmaceutical, grocery, lending, travel, utilities, etc. In one example, for building and testing the hypothesis, six (6) months of data is considered. Of this, five (5) months of historical data can be used for calculating cap value. The next one (1) month data can be used for testing this cap value. To solve the problem of deciding a cap value, following factors provided in step 204-208 can be utilized.

In step 204, process 200 can implement business category operations. It is noted that merchants from a same business category have certain commonalties in their transaction patterns. According, use of a business category enable step 204 to evaluate how volumes from a certain merchant grow seeing the volume growth of the other near players in the same category. Within a business category, the merchants can be binned based on their daily settlement amounts. Each bin has merchants which are near players to each other in terms of volumes. Such a grouping allows process 200 to identify the top, medium and bottom players within a business category. The maximum settlement amount of a bin can be taken as a cap value for all the merchants within that bin. This can be termed as ‘Category Bin Maximum Amount’ for a merchant.

It is further noted that the maximum settlement amount of a bin can be taken as a cap value for all the merchants within that bin. However, maximum value could also very well be an outlier for a category bin, thus we can take a 99.5th percentile value (e.g. slightly lower, still representative of the maximum limit of the group, etc.) can be used in some embodiments to eliminate outliers. Hence, 99.5^{th} percentile value of the settlement amounts of a category bin is taken as ‘Category Bin Maximum Amount’ for a merchant.

In step 206, process 200 can implement merchant-wise daily settlements operations. The daily settlement amounts for individual merchants over a period enables process 200 to analyze the recent transactions trend for each merchant. From various statistics that could be obtained from daily settlement values of a merchant, process 200 can use the 99th percentile as it is in line with the objective. The 99th percentile value covers most of the cases and also eliminates outliers (aberrant peaks that may be out of capacity of float). This value is named as ‘99th Percentile amount’.

In step 208, process 200 can implement merchant's daily settlement amount range and distribution of various amounts across range operations. Range can be the difference between minimum and maximum settlement amount for a period. Process 200 can determine how daily settlement amounts for various days are distributed within the range as it allows us to evaluate where are the values concentrated and what is the variation among them. Since daily volumes are impacted by a lot of external factors like business growth, seasonality, merchant shifting volumes to other payment gateway etc., thus range and distribution are highly dynamic in nature. ‘Percentile Ratio Amount’ is introduced. In order to have a cap value that accounts for dynamism, the output of step 208 can implement process 300.

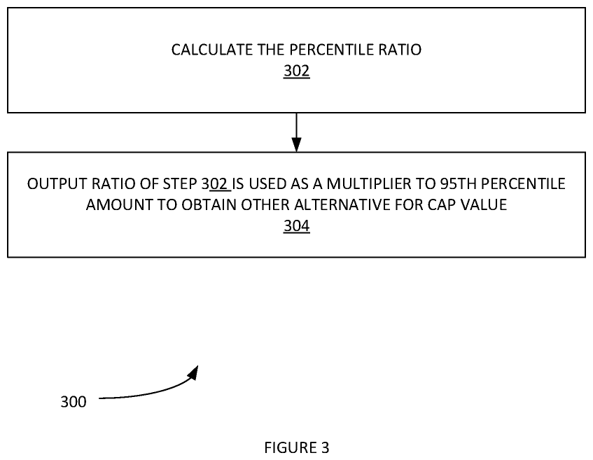

FIG. 3 illustrates an example process 300 for accounting for dynamism in a cap value provided by process 200, according to some embodiments. In step 302, process 300 can calculate the percentile ratio amount. Process 300 can implement this with the following equation:

Percentile Ratio Amount=95th percentile amount*75th percentile amount/50th percentile amount.

Based on this output, when this distribution of settlement values is such that lower values see higher density of settlements then our cap value should not be unnecessarily high, and tend towards a lower value. On the other hand, when a higher density is seen towards large values, the cap should be set to a high value that can take care of such distribution. To understand the variation or jump from mid-level volumes (e.g. days when merchant did an average volume) to upper level volume (e.g. days when merchant did well in terms of volume), the ratio of 75th percentile amount to 50th percentile amount can be taken in one example. This can be based on example sample data that indicates a 75th percentile amount, as a good representative of upper-middle range and 50th percentile for a lower-middle range. Therefore, these two percentile amounts are significant to analyze a jump.

This ratio is used as a multiplier to 95th percentile amount to obtain other alternative for cap value in step 304. Step 304 can determine how a value that covers most of the cases but is far away from the outliers (e.g. 95th percentile) can shift and attain a higher value going by the behavior of mid-range amounts. These three alternatives are now evaluated to compute cap value for merchants in processes 400-500 infra.

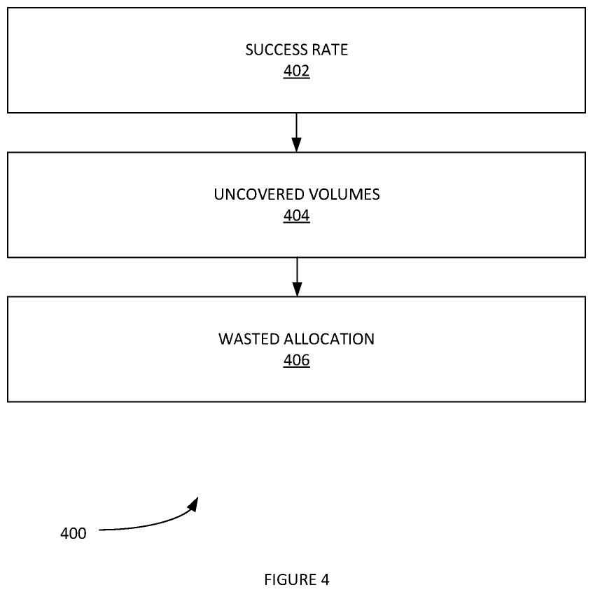

FIG. 4 illustrates an example process 400 for utilizing metrics for indicating a performance of cap alternative(s), according to some embodiments. To indicate the performance of cap alternatives, process 400 obtains and determines the following metrics. In step 403, process 400 provides a success rate metric. The success rate metric can be the number of cases out of total number of settlement cases that the given cap value could cover. Higher the success rate, the better is the performance of the given cap value.

In step 404, process 400 can determine and analyze an uncovered volumes metric. The uncovered volumes denotes the amount that could not be covered by the allocated cap(X), where:

Uncovered Volumes=(Sum total of amounts that cap could not cover/Total Settlement Volume)

If settlement value was X, and cap was Y where Y<X, then (X−Y) would give uncovered volume for a particular settlement. It is noted that the higher the uncovered volume proportion, the poorer is the performance of cap alternative.

In step 406, process 400 can determine and analyze a wasted allocation metric.

The wasted allocation metric can be determined as:

(Unutilized allocation/Total Settlement Volume).

Wasted or Extra Allocation or unutilized cap amount can be a factor to be considered as per the objective. This amount can be better utilized to provide an early settlement (lending) for some other merchant. It is noted that when a significantly high amount is wasted as unutilized capacity to cover very less settlement volume, it is not an optimum cap allocation. According, these cap values are calculated on the merchant wise settlement data for a period of five (5) months. Testing has been done on the data of the month which followed this 5-month period.

Process 400 can be used to judge the performance of the cap alternatives based on above metrics. The results show that each of these values stand best or worst in some or the other situation. A small difference in 99th and 100th percentile amount makes 99th a good candidate for cap value as the amount that 99th percentile fails to cover is less, and we don't lose out much on interest earned from lending. However, when this difference is high, capping the settlements on 99th percentile leads to heavy loss in possible earnings from interest. In such a situation, Percentile Ratio Amount (PRA) can be used. Since PRA is guided by the jump from 50th to 75th percentile amount, it adjusts its value as per the distribution. Accordingly, it makes sure that cap value obtained is in agreement with the values where high density is seen (e.g. a greater number of daily settlement cases are seen in a region with in a distribution). On the other hand, PRA may not be appropriate in cases where density is fairly uniform throughout the distribution as it gives a high cap value (due to a steady jump from 50th to 75th) that leads to huge wasted allocation.

In some examples, a Category Bin Maximum Amount (CBMA) can be used when near players within a category bin have less variance in their individual maximum daily settlement amounts. Hence, each of these amounts have their specific scenario where they are best suited. In this way, to make our cap alternative value arrive to a suitable value considering all these challenges automatically. There is a need to arrive at a combination of these three alternatives.

The ‘Cap Formula’ which is a combination of above alternatives is introduced. It is given as:

Maximum(Minimum(Percentile Ratio Amount,Category Bin Maximum Amount),99th Percentile Amount).

The performance of this formula in comparison to existing cap alternatives can be tested and a score can be given to each of these four alternatives (e.g., with the cap formula) in different performance metrics by process 400:

Success Rate Score: the higher the success rate, higher the score;

Uncovered Volume Score: the higher the uncovered volume, lower the score; and

Wasted Allocation Score: the higher the wasted allocation, lower the score.

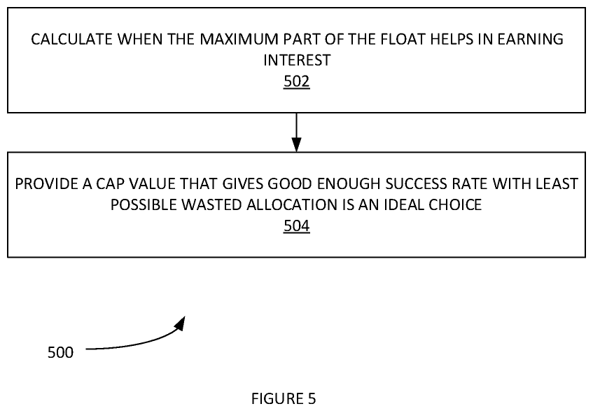

FIG. 5 illustrates an example process 500 for float optimization, according to some embodiments. Process 500 can be used to determine an advantageous method of utilizing the float is when the maximum part of the float helps in earning interest (e.g. less wasted allocation). Accordingly, in step 502, process 500 can calculate when the maximum part of the float helps in earning interest. For merchants, the maximum benefit of lending is when the settlements are done to them as promised on the same day itself with least number of exceptions (e.g. a high success rate).

It is noted that maintaining a high maximum limit does provide for covering maximum daily settlement cases but this high allocated amount is not well utilized. However, maintaining a low maximum limit on the other hand provides for a maximum utilization but might not serve for most of the days. Therefore, in step 504, process 500 can provide a cap value that gives a good enough success rate with least possible wasted allocation is an ideal choice. Step 504 can calculate an optimality metric has been. The optimality metric can serve the final judgement and the objective of giving a cap. Optimality can be determined as the product of success rate score, uncovered volume score and wasted allocation score. The higher the optimality, the better is the performance. In one embodiment, the optimality is highest for ‘The Cap Formula’ across all the business categories and all the merchants.

This process of deciding a maximum lending limit can be used for a setup where a payment gateway with a surplus amount in nodal account utilizes it for providing a daily lending service (settling money earlier than the agreed schedule) to its merchants where the amount settled early is not fixed and is dependent on various factors. The objective is to lend the surplus amount such that it is a win-win situation for merchants as well as the lending entity. ‘The Cap Formula’ serves as the best cap alternative in the above-mentioned setup.

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States Patent:

1. A computerized method for determining a maximum daily limit for a merchant on a settlement comprising:
with an early settlement capping module operating in a server:
deciding a maximum lending limit, wherein the maximum lending limit is used for a setup of a payment gateway with a surplus amount that a nodal account utilizes for providing a lending service to a set of merchants;
analyzing the impact of a set of alternative factors that are used as a cap value for the maximum lending limit, wherein the cap value comprises an upper limit put to a daily settlement done to a merchant in the set of merchants in order to prevent risk and optimally lend float; and
based on the cap value, implementing a lending operation through the lending service to the set of merchants.

2. The computerized method of claim 1, wherein an upper limit to an early settlement amount is used to meet a risk prevention objective and an optimal float lending objective.

3. The computerized method of claim 1, wherein lending is implemented on a daily basis.

4. The computerized method of claim 3, wherein the amount lent daily is not fixed and is dependent on a specified set of factors.

5. The computerized method of claim 4, wherein the specified set of factors used to determine the amount lent daily comprises a merchant's business category; a set of near players to the merchant within said category; a range of daily volumes; and a distribution of daily volumes within said range.

6. The computerized method of claim 1, wherein the set of alternatives are obtained as: Maximum(Minimum(Percentile Ratio Amount, Category Bin Maximum Amount), 99th Percentile Amount).

7. The computerized method of claim 1, wherein a cap value is determined by a set of steps that comprise:
implementing data preparation operations, wherein a merchant-wise daily settlement data is consolidated for the set of the merchants across various business categories;
implementing a specified business category operation;
implementing a set of merchant-wise daily settlements operations;
implementing a merchant's daily settlement amount range and distribution of various amounts across range operations.

8. The computerized method of claim 7, wherein a dynamism in a cap value is accounted for by the steps of:
calculating a percentile ratio amount; and
determining a value that covers a specified range of the cases but is a specified distance from a set of 95th percentile outliers.

9. A computerized system useful for providing an estimated legal cost to a client system based on a dynamic legal cost estimation model comprising:
at least one processor configured to execute instructions;
at least one memory containing instructions when executed on the at least one processor, causes the at least one processor to perform operations that:
with an early settlement capping module operating in a server:
decide a maximum lending limit, wherein the maximum lending limit is used for a setup of a payment gateway with a surplus amount that a nodal account utilizes for providing a lending service to a set of merchants;
analyze the impact of a set of alternative factors that are used as a cap value for the maximum lending limit, wherein the cap value comprises an upper limit put to a daily settlement done to a merchant in the set of merchants in order to prevent risk and optimally lend float; and
based on the cap value, implement a lending operation through the lending service to the set of merchants.

10. The computerized system of claim 9, wherein an upper limit to an early settlement amount is used to meet a risk prevention objective and an optimal float lending objective.

11. The computerized system of claim 9, wherein lending is implemented on a daily basis.

12. The computerized system of claim 11, wherein the amount lent daily is not fixed and is dependent on a specified set of factors.

13. The computerized system of claim 12, wherein the specified set of factors used to determine the amount lent daily comprises a merchant's business category; a set of near players to the merchant within said category; a range of daily volumes; and a distribution of daily volumes within said range.

14. The computerized system of claim 9, wherein the set of alternatives are obtained as: Maximum(Minimum(Percentile Ratio Amount, Category Bin Maximum Amount), 99th Percentile Amount).

15. The computerized system of claim 9, wherein the memory containing instructions when executed on the at least one processor, causes the at least one processor to perform operations that: determine the cap value is determined by a set of steps that comprise:
implement a data preparation operation, wherein a merchant-wise daily settlement data is consolidated for the set of the merchants across various business categories;
implement a specified business category operation;
implement a set of merchant-wise daily settlements operations;
implement a merchant's daily settlement amount range and distribution of various amounts across range operations.

16. The computerized system of claim 15, wherein the determining the dynamism in the cap value further comprises calculating a percentile ratio amount.

17. The computerized system of claim 16, wherein the determining the dynamism in the cap value further comprises determining a value that covers a specified range of the cases but is a specified distance from a set of 95th percentile outliers.
